(19) United States
(12) Patent Application Publication
(10) Pub. No.: US 2020/0215657 A1
(43) Pub. Date: Jul. 9, 2020

(54) BLOCKING OF LENSES

(71) Applicant: SCHNEIDER GMBH & CO. KG, Fronhausen (DE)

(72) Inventors: Gunter SCHNEIDER, Marburg (DE); Stephan HUTTENHUIS, Niederweimar (DE); Benjamin SCHNEIDER, Lohra (DE)

(73) Assignee: SCHNEIDER GMBH & CO. KG, Fronhausen (DE)

(21) Appl. No.: 16/488,442

(22) PCT Filed: Feb. 20, 2018
(86) PCT No.: PCT/EP2018/054099

§ 371 Date: Mar. 3, 2020

(30) Foreign Application Priority Data
Feb. 24, 2017 (DE) 10 2017 001 794.8

(51) Int. Cl. B24B 13/005

(52) U.S. Cl. CPC B24B 13/0055

(57) ABSTRACT

An apparatus for blocking of lenses, in particular eyeglass lenses. The blocking apparatus has a blocking station, which is designed for at least partially chronologically overlapping blocking of at least two lenses directly to one block piece apiece that is provided with a block material. In addition, the blocking apparatus has an aligning apparatus which is designed for at least partially chronologically overlapping, position-controlled rotating of the lenses around three rotational axes in respectively one defined rotational position. Moreover, the blocking apparatus has a transport apparatus, which is designed, in particular, for at least partially chronologically overlapping transport of the lenses to one block piece apiece that is located in the blocking station and for holding the lenses in the respectively defined rotational position.

### BACKGROUND OF THE INVENTION

### Field of the Invention

The invention relates to methods for blocking lenses, in particular eyeglass lenses, and to an apparatus for blocking of lenses, in particular eyeglass lenses, as well as to a block material feeding device for an apparatus for blocking of lenses and to a method for blocking and processing a lens.

### Background of the Invention

Lenses, in particular optical lenses, quite especially eyeglass lenses, are blocked for (additional) processing and/or (additional) coating usually on a so-called block piece as a holder by means of a so-called block material, i.e., connected in a positive, integral and/or non-positive manner with the block piece with a side that is finished or still to be processed and thus fastened to the block piece. The block piece is made of metal and/or plastic and serves in particular to hold the lens that is fastened thereto—i.e., blocked—in a precise and defined manner for one or more processing task(s) and/or coating(s). The block piece-lens pair that results from the blocking can be held in a processing machine and/or coating device on the block piece.

In particular, a blocked eyeglass lens can be machined on its rear and/or front surface with respect to its optical action and/or on the edge for integration into an assigned eyeglass frame with geometrically defined (milling/turning) or geometrically undefined (grinding/polishing) cutting edge and/or can be coated on its rear and/or front surface for achieving additional actions (increase in scratch resistance, antireflection properties, mirroring, hydrophobic properties, etc.). Such an eyeglass lens can be processed and/or coated as early as before the blocking on one or both optically active surfaces and/or on the edge.

Eyeglass lenses are defined as optical lenses or lens blanks (blanks) for eyeglasses that consist of commonly-used transparent materials, such as plastic (e.g., polycarbonate, CR-39, Hi-index) or mineral glass, and with any (preliminary) shape of the peripheral edge of the lens and/or the lens blank. On the surface on which they are blocked, such eyeglass lenses can be provided with a film, a lacquer or the like in order to protect this surface from contamination and damage and/or to improve the adhesion properties between eyeglass lens and block material.

Below, the term “lens” is used both for a lens that was processed and/or coated in advance on one side (rear or front surface) and in which the other side is still to be processed and/or coated, and for a lens that is still to be processed and/or coated on both sides.

As block material, metal alloys with low melting points (e.g., alloy) or thermoplastics, i.e., thermoplastic materials, or non-thermoplastic materials, in particular hardening adhesives (e.g., light-curing glues), but also adhesive tapes or the like can be used. Depending on the block material that is used, various requirements or process sequences arise during blocking.

The focus of this invention is the blocking of a lens without support rings. In this case, the lens and/or a side of the lens is connected directly to a block piece that is provided with block material and/or is blocked thereon.

In addition, the focus of this invention is the blocking of a lens, in which an exclusively integral connection between the lens and exactly one block piece is produced by means of a block material. A block piece-lens pair with exactly one lens and exactly one block piece results from this blocking. This blocking ensures that the resulting block piece-lens pair can be held in a processing machine and/or coating device on the block piece, and an optically active surface and/or a front and/or back surface of the lens can be processed and/or coated. The object is thus not an edge processing for adaptation to an eyeglass frame.

In comparison to the edge processing, the block piece-lens pair in the case of a surface processing must withstand higher forces and forces that act in other directions. In particular, the lens and the block piece must be connected to one another rigidly, i.e., even in a torque-proof manner with respect to one another. The block piece must not be deformed and/or must not be deformable by the forces that are exerted in the surface processing on the lens. A block piece that is suitable for this blocking has a diameter that is larger than the diameter of the ultimately-generated utility surface of the lens.

On the bottom part of the block piece, the block piece-lens pair for processing and/or coating the lens can be held in a workpiece chuck, processing apparatus and/or coating apparatus, wherein the block piece-lens pair can be detached from the workpiece chuck.

For the (additional) processing and/or (additional) coating of a lens, for the consumption of block material, for the stability of the connection between lens and block piece, and for the reduction of shrinkage in the block material, it is advantageous to orient the lens as precisely as possible relative to the block piece. In this case, the term “to orient” is defined as the turning and/or tilting and/or rotating of the lens in space around three rotational axes and/or tilting axes and/or axes of rotation that are typically perpendicular to one another—frequently referred to as the A-, B- or C-axis—in a defined rotational position.

An apparatus for blocking eyeglass lenses is known from German Patent Application DE 10 2008 023 093 A1 and corresponding U.S. Pat. No. 8,616,150 B2. This has a measuring station for acquiring orientation and geometry information of an eyeglass lens that is to be blocked and a blocking station in which the eyeglass lens can be blocked by means of a temporarily deformable block material on a block piece. In addition, the known blocking apparatus has a transport device that has a retaining head for the eyeglass lens, by means of which device a relative movement can be generated between the eyeglass lens that is held on the retaining head, on the one hand, and the measuring station as well as the blocking station, on the other hand. In order to make possible the most universal use of the blocking apparatus, the transport device has at least four position-controlled movement axes, by means of which the eyeglass lens can be positioned in a defined manner taking into consideration the orientation and geometry information of the eyeglass lens that is acquired in the measuring station relative to a block piece that is located in the blocking station and can be held during the blocking in the defined relative position to the block piece while leaving a block material-seat gap between eyeglass lens and block piece.

In the known blocking apparatus, the eyeglass lens that is to be blocked by means of the retaining head of the transport device is removed from the measuring station and then oriented by means of the retaining head. To this end, the retaining head, which is controlled in space at the angle of rotation, can be rotated around three rotational axes that are perpendicular to one another into a defined rotational position. Then, the eyeglass lens is moved by means of the transport device into a block piece that is located in the blocking station and in this case held in the defined rotational position on the retaining head. Finally, the lens is blocked on the block piece.

### SUMMARY OF THE INVENTION

One object of this invention is to improve the known blocking apparatus and/or the known blocking method with respect to the throughput, the accuracy, the design, the reliability, the possible uses, and/or the costs.

It is self-explanatory that configurations, embodiments, advantages and the like, which are cited below only for one aspect of the invention for purposes of avoiding repetitions, correspondingly apply relative to the other aspects of the invention.

This being said, this invention is described in more detail below.

The basic idea of a first aspect of the invention is a simultaneous orientation of at least two lenses and a simultaneous blocking of at least two lenses, in particular a simultaneous connecting and/or joining of the two lenses with one block piece apiece.

To this end, the apparatus according to the invention has a blocking station that is designed for at least partially chronologically overlapping blocking, in particular connecting and/or joining, of at least two lenses directly to and/or with one block piece apiece that is provided with a block material. In addition, the apparatus according to the invention has an aligning apparatus, which is designed for at least partially chronologically overlapping, position-controlled rotating of the lenses around three rotational axes in respectively one defined rotational position. In addition, the apparatus according to the invention has a transport apparatus, which is designed for in particular at least partially chronologically overlapping transport of the lenses to one block piece apiece that is located in the blocking station and for holding the lenses in the respectively defined rotational position.

In the case of “at least partially chronologically overlapping” processes, at least one time segment of a process takes place simultaneously with a time segment of another process, wherein the two time segments can be different or the same length. Preferably, the one process is performed completely at a time in which the other process is performed.

The term “position-controlled” is defined here in terms of CNC machines. This means that, e.g., a part of the apparatus according to the invention is automated and positioned in a controlled manner by means of CNC electronics. Typically, the CNC electronics monitor all time derivatives of the position that are relevant for the positioning using multiple control circuits that are nested in one another and are in each case closed per se. If multiple movement axes are present, the axes can be interpolated with one another.

The apparatus according to the invention makes possible a high and/or higher throughput, i.e., a high and/or higher number of blocking processes per time device.

Preferably, the three rotational axes intersect and/or are at least essentially perpendicular to one another.

Preferably, the aligning apparatus is designed along a linear axis in addition to the at least partially chronologically overlapping, position-controlled moving of the lenses.

It is preferred when the aligning apparatus has two aligning devices, which are designed in each case for position-controlled rotating of the lenses around the three rotational axes in the respectively defined rotational position. Preferably, each aligning device can be rotated in a position-controlled manner around the three rotational axes and, optionally, can be moved in a position-controlled manner along the linear axis. Preferably, the three rotational axes are perpendicular to one another.

The linear axis of the aligning apparatus preferably runs parallel or perpendicular to the linear axes of the transport apparatus. However, it can also be provided that the linear axis of the aligning apparatus intersects at least one linear axis of the transport apparatus or runs askew to linear axes of the transport apparatus. In particular, the linear axis of the aligning apparatus can intersect a linear axis of the transport apparatus at an angle of approximately 5° to approximately 45°, in particular approximately 15°.

In a preferred embodiment of the apparatus according to the invention, the blocking station has at least two block piece seats for one block piece apiece. The lenses are connectable in a detachable manner to respectively one block piece-lens pair in a joining position of the block piece seats by means of the transport apparatus, at least partially chronologically overlapping with one block piece apiece that is located in the respective block piece seat and is provided with block material. Preferably, the lenses can be pressed in the joining position of the block piece seats by means of the transport apparatus respectively into and/or at and/or against the block material of a block piece that is located in the respective block piece seat and is provided with block material. The respective lens and the respective block piece remain separated from one another; they thus do not adjoin one another. Block material remains between the respective lens and the respective block piece.

Advantageously, the blocking station with its block piece seats can be moved relative to the transport apparatus, in particular can be rotated around a rotational axis. In this case, the block piece seats can be coupled with respect to movement. Preferably, by means of moving the blocking station, the block piece seats
can be moved into a receiving position, in which one block piece apiece can be arranged in one block piece seat apiece, and block material can be applied to the block pieces that are located in the block piece seats, can be moved into the joining position,
can be moved into a rest position, in which the block material of the block piece-lens pair can harden at least partially, and/or
can be moved into a removal position, in which the block piece-lens pairs can be removed from the block piece seats.

This preferred embodiment makes it possible to parallel at least two of the method steps “to arrange block pieces in block piece seats and to apply block material to the block pieces,” “joining,” “partial hardening,” and “to remove block piece-lens pairs.” Thus, for example, the block material of two block piece-lens pairs can at least partially harden without the joining position of these two block piece-lens pairs being used. Thus, a high and/or higher throughput can be achieved.

This is especially efficient when using a thermoplastic block material. So that the thermoplastic block material can harden without or with as few undesirable effects as possible, such as shrinkage, as well as economically, the thermoplastic block material can cool typically at room temperature without active cooling over several seconds, in particular more than 60 s. If more than two block piece seats are present and are arranged in a suitable manner in the blocking station, at least one part of the cooling time of two block piece-lens pairs can be used in order to implement additional ones of the previously-mentioned method steps, i.e., to generate, e.g., additional block piece-lens pairs by joining.

In an especially preferred embodiment, the blocking station has four block piece seat pairs with two block piece seats apiece. The block piece seat pairs are arranged in the movable blocking station so that a first block piece seat pair can be moved into the receiving position, while a second block piece seat pair can be moved into the joining position, and a third block piece seat pair can be moved into the rest position, and a fourth block piece seat pair can be moved into the removal position. Thus, the previously-mentioned method steps can be embodied at least partially chronologically overlapping.

Preferably, the transport apparatus and the aligning apparatus are decoupled from one another with respect to movement. When the transport apparatus moves, the aligning apparatus thus moves, not necessarily with the transport apparatus. Moving the transport apparatus does not produce or cause any moving of the aligning apparatus. In this case, the transport apparatus can be designed for removing lenses from the aligning apparatus. To this end, the transport apparatus can have at least two retaining heads for holding the lenses in the respectively defined rotational position. By means of the aligning apparatus, in particular by means of its aligning devices, the lenses can then be rotated relative to the respective retaining head in the respectively defined rotational position.

It has proven advantageous when the transport apparatus has two linear axes that run parallel to one another, preferably wherein
one, in particular precisely one, of the two linear axes is position-controlled,
the lenses can be moved along the one linear axis, in particular sequentially to the aligning apparatus, and along the other in particular position-controlled linear axis, in particular at least partially chronologically overlapping with one block piece apiece that is located in the blocking station,
the transport apparatus has a first lens traversing device in particular with the one linear axis and another linear axis, wherein by means of the first lens traversing device, the lenses can be moved in particular sequentially to the aligning apparatus, in particular to its aligning devices, and can be placed in the aligning apparatus, in particular in its aligning devices, and/or
the transport apparatus has a second lens traversing device, in particular with the other preferred position-controlled linear axis and another preferred position-controlled linear axis, wherein by means of the second lens traversing device, the lenses can be removed in particular at least partially chronologically overlapping from the aligning apparatus, in particular from its aligning devices, can be moved from the aligning apparatus, in particular from its aligning devices, to one block piece apiece that is located in the blocking station, in particular to a block piece seat pair of the blocking station in its joining position, and can be connected respectively with the one block piece apiece that is provided with block material to respectively one block piece-lens pair.

The combination of these features makes possible an economical parallelization of the objects of the two lens traversing devices and the aligning apparatus and the blocking apparatus. Thus, for example, two block piece-lens pairs can be generated by joining by means of the second lens traversing device, while two additional lenses are transported by means of the second lens traversing device, in particular sequentially to the aligning apparatus, and then can be aligned there by means of the aligning apparatus.

Preferably, for transport of the lenses, the transport apparatus has multiple movement axes, namely exclusively multiple linear axes and a rotational axis. In this case, numerous of the linear axes can run parallel to one another.

The apparatus preferably has one, in particular precisely one, centering device for centering a lens that is to be blocked and/or one, in particular precisely one, preferably optical measuring station for acquiring orientation and geometry information of a lens that is to be blocked. The transport apparatus is designed in this case for in particular sequential transport of the lenses to the centering device and/or to the measuring station. To this end, the transport apparatus can have the following:
a lens feeding device, by means of which the lenses can be removed in particular sequentially from a supply container, can be moved from the supply container to the centering device, and can be placed in the centering device,
a pivoting device, by means of which the lenses can be removed in particular sequentially from the centering device and can be moved from the centering device to a transfer position, and can be pivoted in particular by approximately 180°,
a first lens traversing device, by means of which the lenses can be received in particular sequentially from the transfer position, can be moved to the measuring station, can be placed in the measuring station, can be removed from the measuring station, can be moved to the aligning apparatus, in particular relative to its aligning devices, and can be placed in the aligning apparatus, in particular in its aligning devices, and/or
a second lens traversing device, by means of which the lenses can be removed in particular at least partially chronologically overlapping from the aligning apparatus, in particular from its aligning devices, can be moved from the aligning apparatus, in particular from its aligning devices, to one block piece apiece that is located in the blocking station, in particular to a block piece seat pair of the blocking station in its joining position, and can be connected respectively with the one block piece apiece that is provided with block material to respectively one block piece-lens pair.

This configuration makes possible an economical realization, since for implementing a parallelization, not all devices are provided twice but rather individual devices of the apparatus according to the invention are exclusively occupied sequentially by the lenses.

Preferably, the apparatus has a conveyor belt, by means of which a supply container for lenses and block pieces can be moved exclusively in one direction. In this configuration, the supply container for removing a lens or a block piece and for inserting a block piece-lens pair is not moved in opposite directions (forward and back). To this end, the lens can be removed at another position of the same supply container as the block piece and/or the block piece-lens pair can be inserted at a position of the same supply container that is different by turns.

According to a second aspect of the invention, the previously-illustrated object is achieved by an apparatus for blocking of lenses, in particular eyeglass lenses, that has at least one block piece seat for a block piece.

In a first preferred embodiment of the apparatus according to the invention, the block piece seat can be moved by means of a conveyor into a receiving position, in which a block piece can be placed by means of a block piece feeding device into the block piece seat, and block material can be applied by means of a block material feeding device to the block piece that is located in the block piece seat. In addition, the block piece seat can be moved by means of the conveyor into a joining position, in which a lens can be connected in a detachable manner to a block piece-lens pair by means of a transport apparatus with the block piece that is located in the block piece seat and is provided with block material. Here, the block piece that is provided with block material is thus transported into the block piece seat for blocking.

Preferably, the apparatus is designed so that two block piece seats can be moved by means of the conveyor simultaneously from the respective receiving position into the respective joining position.

In a second preferred embodiment of the apparatus according to the invention, a major axis of the block piece seat is inclined with respect to the vertical. Preferably, the block piece seat has a support for a block piece, wherein the normal through the midpoint of the support is inclined with respect to the vertical. It is preferred when the inclination of the block piece seat and/or the support can be changed.

Preferably, the apparatus has multiple block piece seats, wherein at least one major axis of a block piece seat with respect to the vertical has an inclination (non-zero) that is different from a major axis of another block piece seat.

Preferably, for this apparatus, a block piece is used, which has a receiving surface for a lens, wherein the normal at the midpoint of the receiving surface of the block piece is inclined with respect to the vertical, and the block piece is inserted into a block piece seat, so that liquid block material that is applied on the receiving surface is distributed as uniformly as possible and/or over the entire surface between lens and block piece during blocking with a lens, and/or does not flow from the receiving surface, in particular wherein the absolute value of the resulting inclination of the normal at the midpoint of the receiving surface of the block piece with respect to the vertical is not more than approximately 3°, preferably not more than approximately 1°.

Advantageously, the blocking apparatus can detect a rotational position of the block piece and can accordingly change these requirements.

In a third preferred embodiment of the apparatus according to the invention, the apparatus has means, by means of which it is possible to detect whether a block piece is arranged in an in particular torque-proof manner in the block piece seat. The means comprise in particular a dynamic air speed indicator.

The features of two or three of the preferred embodiments can be combined with one another. In addition, the apparatus according to the second aspect of the invention can have features of the apparatus according to the first aspect of the invention.

According to a third aspect of the invention, the previously-illustrated object is achieved by a method for blocking of lenses, in particular eyeglass lenses that comprises the following method steps:
a) At least two lenses are rotated by means of an aligning apparatus at least partially chronologically overlapping in a position-controlled manner in respectively one defined rotational position.
b) The lenses are moved by means of a transport apparatus in particular at least partially chronologically overlapping with one block piece apiece that is located in a blocking station and in this case are held in the respectively defined rotational position.
c) The lenses are connected in a detachable manner in the blocking station by means of the transport apparatus at least partially chronologically overlapping using a block material directly with respectively one of the block pieces in respectively one block piece-lens pair.

Step a) is thus implemented for both lenses at least partially chronologically overlapping. In addition, step c) is implemented for both lenses at least partially chronologically overlapping. Step c) is implemented for these two lenses according to step a) and according to step b).

The method according to the invention makes possible a high and/or higher throughput.

In a preferred embodiment of the method according to the invention:
at least two block pieces are arranged in the blocking station,
one block material apiece is applied to these two block pieces that are located in the blocking station, these two block pieces that are provided with block material are moved by means of the blocking station relative to the transport apparatus into a joining position, in which the lenses are connected in a detachable manner to respectively one block piece-lens pair at least partially chronologically overlapping with one block piece apiece that is provided with block material, preferably wherein the lenses are pressed by means of the transport apparatus at least partially chronologically overlapping in the block material of one of the block pieces that is provided with block material,
the two thus generated block piece-lens pairs are moved by means of the blocking station relative to the transport apparatus into a rest position, in which the block material partially hardens,
the two block piece-lens pairs are moved by means of the blocking station relative to the transport apparatus into a removal position, in which the two block piece-lens pairs are removed from the blocking station preferably at least partially chronologically overlapping, and/or
the blocking station is rotated around a rotational axis.

Preferably, it is provided that at least partially chronologically overlapping with:
the detachably connecting to block piece-lens pairs,
at least one additional block piece is arranged in the blocking station,
block material is applied to this additional block piece that is located in the blocking station,
at least one block piece-lens pair pauses in the rest position for partial hardening of the block material, and/or
at least one additional block piece-lens pair is removed from the blocking station.

In particular, a high degree of parallelization is reached with the combination of these steps.

According to a fourth aspect of the invention, the previously-indicated object is achieved by a block material feeding device which serves to feed block material for an apparatus for blocking of lenses, in particular eyeglass lenses, preferably for an apparatus as previously explained. When using a thermoplastic block material for blocking of lenses of the kind in question, the smallest possible amounts of block material per blocking process are to be used, typically 2 g to 30 g. This requires a very precise metering. Before the application onto a block piece, the block material must be melted by heating to at least the melting point. In the thermoplastic block materials of the kind in question, the respective melting point is comparatively low, typically between approximately 70° C. and approximately 90° C. If the block material is melted, sedimentation begins. In this case, suspended matter is stored in the block material. This can lead to accidentally changed properties of the block material. During application of the molten block material to a block piece, it is best to keep too much block material from dripping and/or pulling strands.

The block material feeding device according to the invention is designed for automated loading of a thermoplastic block material in a solid aggregate state, preferably in rod form, for heating in certain areas of the thermoplastic block material, preferably a front area of the upright circular cylinder and for dosed metering of the molten block material.

The block material feeding device according to the invention makes possible a precise and reliable blocking.

Preferably, the block material feeding device is designed for in particular cooling in certain areas of the block material that is located in the block material feeding device.

The block material feeding device according to the invention is designed so that the temperature of the block material 3, which is applied to a block piece 5, which is located in a block piece seat 11 in the receiving position, lies in a range of approximately 60° C. to approximately 80° C.

According to a fifth aspect of the invention, the previously-indicated object is achieved by a method for blocking and processing a lens in which the lens is blocked in a blocking apparatus on a block piece that is provided with block material, in a defined rotational position relative to the block piece. At least one piece of information about the defined rotational position of the lens is transmitted in electronic form to a processing apparatus. The blocked lens is processed by the processing apparatus taking into consideration the transmitted information about the defined rotational position of the lens.

The transmission can be done in a wireless or wired manner It can be performed by the blocking apparatus and/or by another apparatus.

The blocking apparatus can be designed as described for the first and/or second aspect of the invention.

Preferably, the lens in the blocking apparatus is rotated around three rotational axes in a position-controlled manner in the defined rotational position relative to the block piece.

It is preferred when the processing of the blocked lens is begun by the processing apparatus at a position that depends on the transmitted information about the defined rotational position of the lens.

According to a sixth aspect of the invention, an inclined block piece seat is used for blocking a lens, in particular an eyeglass lens, on a block piece by means of a block material.

According to a first, independent basic idea of the sixth aspect of the invention, the block piece has a prismatically tilted receiving surface for the lens. During blocking, the block piece is held in the block piece seat in such a way that the receiving surface is oriented at least essentially horizontally.

Preferably, during blocking, the block piece is held in the block piece seat in such a way that during joining with a lens, liquid block material that is applied to the receiving surface is distributed as uniformly as possible and/or over the entire surface between lens and block piece and/or does not flow from the receiving surface, in particular wherein the absolute value of the resulting inclination of the normal at the midpoint of the receiving surface of the block piece with respect to the vertical is not more than 1°.

According to a second, independent basic idea of the sixth aspect of the invention, the block piece has a prismatically tilted receiving surface for the lens. The prismatic tilting of the receiving surface is less than a desired prism of the lens. During processing of the blocked lens, the difference between the prismatic tilting of the receiving surface and the desired prism of the lens is taken into consideration, so that the desired prism of the lens is generated. In principle, a combination that consists of the prismatic tilting of the receiving surface of the block piece and prismatic processing of the lens is carried out here, wherein an advantageous distribution of the block material by the inclined block piece seat is achieved during blocking.

Preferably, a major axis of the block piece seat and/or the normal at the midpoint of a receiving surface of the block piece with respect to the vertical is inclined by 1° to 5°.

Additional aspects, features, advantages, and properties of the present invention follow from the following description of preferred embodiments with reference to the accompanying drawings.

### BRIEF DESCRIPTION OF THE DRAWINGS

FIG. 1 is a top view of a preferred embodiment of a blocking apparatus according to the invention,

FIG. 2 is a perspective view of the blocking apparatus of FIG. 1, wherein the depiction is simplified with parts of the blocking apparatus not shown,

FIG. 3 is another perspective view of the blocking apparatus of FIG. 1, wherein, in turn, the depiction is simplified with parts of the blocking apparatus not shown,

FIG. 4 is view of a blocking station of the blocking apparatus of FIG. 1 in a first state, wherein the depiction is simplified with parts of the blocking apparatus not shown,

FIG. 5 is a perspective view of the blocking station of the blocking apparatus of FIG. 1 in a second state, and

FIG. 6 is a sectional view through a block piece-lens pair.

### DETAILED DESCRIPTION OF THE INVENTION

In the figures, the same reference numbers are used for the same or similar components and devices, wherein the same or corresponding advantages and properties result, even when a repeated description is omitted.

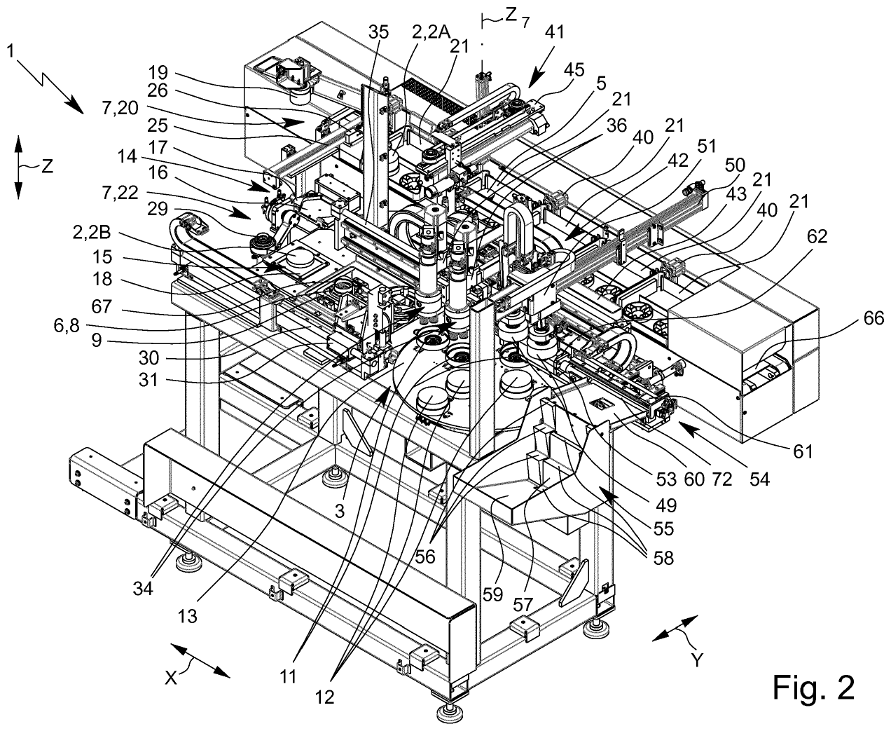

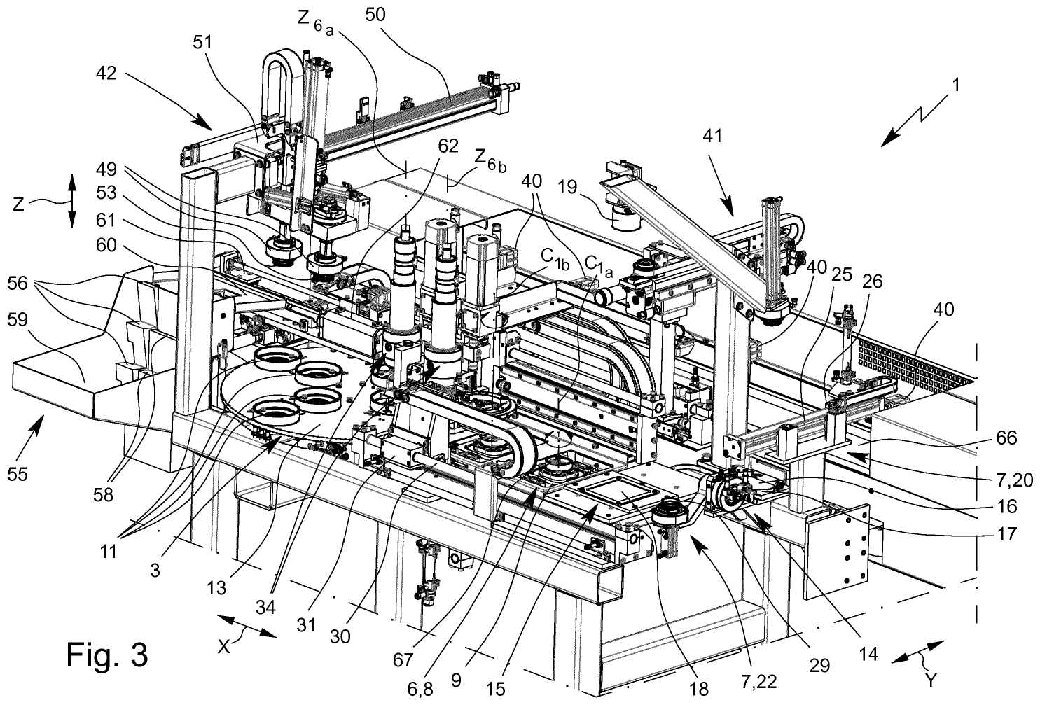

In the description of the figures below, direction indicators are used. These direction indicators relate to the Cartesian coordinate device that is indicated in FIGS. 2 and 3 with arrows X, Y, Z.

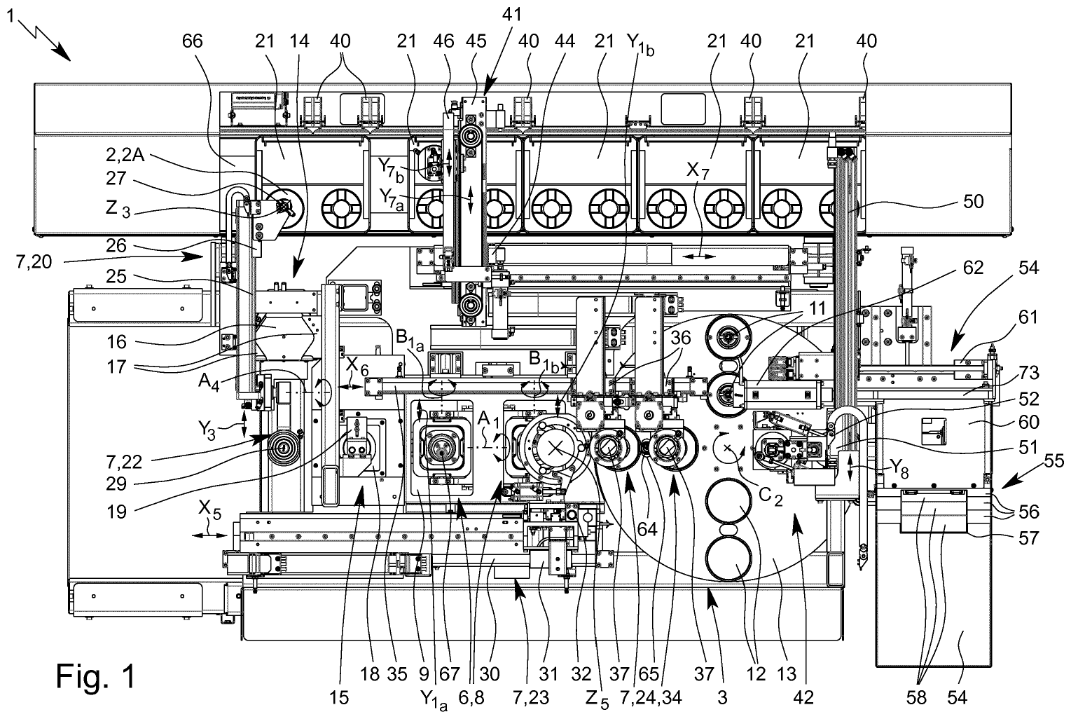

FIG. 1 diagrammatically shows a top view of a preferred embodiment of an apparatus 1 according to the invention for blocking of lenses 2. FIGS. 2 and 3 diagrammatically show various perspective views of the blocking apparatus 1 of FIG. 1, wherein a simplified depiction with parts of the blocking apparatus 1 not shown was selected in order to allow other parts of the blocking apparatus 1 to be viewed.

In the embodiment that is depicted here and is preferred, the lenses 2 are eyeglass lenses, i.e., lenses 2 for eyeglasses. The lenses 2 consist of plastic here. Alternatively, they can consist of glass or the like. The lenses 2 in the example have a diameter of multiple centimeters, in particular of more than 3 cm.

Each lens 2 has two optically active sides here, namely an already-finished cast block side 2A and a processing side 2B that is still to be processed. Here, no processing of the block side 2A is provided either before or after the blocking. Here, only the processing side 2B is to be processed. In this case, this can be a spherical or aspherical processing side 2B. In both cases, the block side 2A and/or the processing side 2B can be convex, concave or flat. In this case, one side is considered convex and/or concave, when it is raised at the base, i.e., curved outward, and/or recessed, i.e., curved inward.

A protective film 73 can be bonded onto the block side 2A of the lens 2.

The apparatus 1 according to the invention has a blocking station 3, which is designed for at least essentially simultaneous blocking of two lenses 2 directly on one block piece 5 apiece that is provided with a block material 4.

In the embodiment that is depicted here and is preferred, a thermoplastic is used as block material 4, preferably as it is described in International Patent Application Publication WO 2011/018231 A and corresponding U.S. Pat. No. 9,340,669 B2.

Moreover, the apparatus 1 according to the invention has an aligning apparatus 6, which is designed for at least essentially simultaneous, position-controlled rotating of the lenses 2 in the three-dimensional space around three rotational axes A₁, B₁ₐ and/or B_{1b}, C₁ₐ and/or C_{1b} in respectively one defined rotational position. In the embodiment that is depicted here and is preferred, the three rotational axes A₁, B₁ₐ and/or B_{1b}, C₁ₐ and/or C_{1b} are at least essentially perpendicular to one another.

In addition, the apparatus 1 according to the invention has a transport apparatus 7, which is designed for at least essentially simultaneous transport of the lenses 2 to one block piece 5 apiece that is located in the blocking station 3 and for holding the lenses 2 in the respectively defined rotational position.

In the embodiment that is depicted here and is preferred, the aligning apparatus 6 is designed in addition for at least essentially simultaneous, position-controlled moving of the lenses 2 along a linear axis Y₁ₐ and/or Y_{1b}.

In the embodiment that is depicted here and is preferred, the aligning apparatus 7 has two aligning devices 8. Each aligning device 8 is designed for position-controlled rotation of a lens 2 around the three rotational axes A₁, B₁ₐ and/or B_{1b}, C₁ₐ and/or C_{1b} in the respectively defined rotational position. To this end, each aligning device 8 can be rotated in a position-controlled manner around the three rotational axes A₁, Bia and/or B_{1b}, C₁ₐ and/or C_{1b}. For this purpose, corresponding drives, joints and sensor systems are provided for each aligning device 8.

In addition, each aligning device 8 can be moved in a position-controlled manner along the linear axis Y₁ₐ or Y_{1b}. To this end, each aligning device 8 has a sled 9 and a guide rail 10. For each sled 9, a drive and an assigned sensor device are provided. Each sled 9 can move on the respective guide rail 10 in the Y-direction. Thus, the corresponding aligning device 8 can be moved in the Y-direction by means of the respective sled 9.

In the embodiment that is depicted here and is preferred, each aligning device 8 has an attaching element 67 that is arranged eccentrically for attaching a lens 2 during the aligning.

In the embodiment that is depicted here and is preferred, the blocking station 3 has eight block piece seats 11 for one block piece 5 apiece. The lenses 2 can be connected in a detachable manner in a joining position of the block piece seats 11 by means of the transport apparatus 7 at least essentially simultaneously with one block piece 5 apiece that is located in the respective block piece seat 11 and is provided with block material 4 to respectively one block piece-lens pair 12.

In particular, the lenses 2 in the joining position of the block piece seats 11 can be pressed by means of the transport apparatus 7 respectively into and/or at or against the block material 4 of a block piece 5 that is located in the respective block piece seat 11 and is provided with block material 4. Between the respective lens 2 and the respective block piece 5, a gap that is at least partially filled with the block material 4 remains. The gap here has a height of approximately 0.2 mm up to approximately 3 mm, in particular from approximately 1 mm to 2 mm.

In the embodiment that is depicted here and is preferred, the blocking station 3 can be moved with its block piece seats 11 relative to the transport apparatus 7 and specifically can rotate around a rotational axis C₂. The block piece seats 11 are coupled with respect to movement. They are arranged on a turntable 13, specifically in pairs, i.e., in four block piece seat pairs with respectively two block piece seats 11 that are arranged beside one another.

In the embodiment that is depicted here and is preferred, the block piece seats 11 can be moved into various positions by moving the blocking station 3, specifically
into a receiving position, in which one block piece 5 apiece can be arranged, in particular can be placed, into respectively one block piece seat 11, and block material 4 can be applied onto the block pieces 5 that are located in the block piece seats 11,
into the already-mentioned joining position,
into a rest position, in which the thermoplastic block material 4 of the generated block piece-lens pairs 12 can at least partially harden, and
into a removal position, in which the block piece-lens pairs 12 can be removed from the block piece seats 11.

The block piece seats 11 are arranged here in the movable blocking station 3 so that a first block piece seat pair can be moved into the receiving position, whereas a second block piece seat pair can be moved into the joining position, and a third block piece seat pair can be moved into the rest position, and a fourth block piece seat pair can be moved into the removal position.

The block piece seats 11 of a block piece seat pair are arranged on the turntable 13 offset from the block piece seats 11 of the other block piece seat pairs by 90°, 180° or 270°. Four of the block piece seats 11 lie on a common inner radius of the turntable 13. The other four block piece seats 11 lie on a common outer radius of the turntable 13.

In this embodiment, the method steps “to arrange block pieces 5 in block piece seats 11 and to apply block material to the block pieces 5,” “joining,” “partial hardening” and “to receive block piece-lens pairs 12” can be implemented simultaneously and/or chronologically overlapping.

In FIGS. 1 and 2, respectively one block piece-lens pair 12 is located in the two block seats 11 in the rest position, and respectively one other block piece-lens pair 12 is located in the two block seats 11 in the removal position. The other block piece seats 11 are empty. In FIG. 3, all block piece seats 11 are empty.

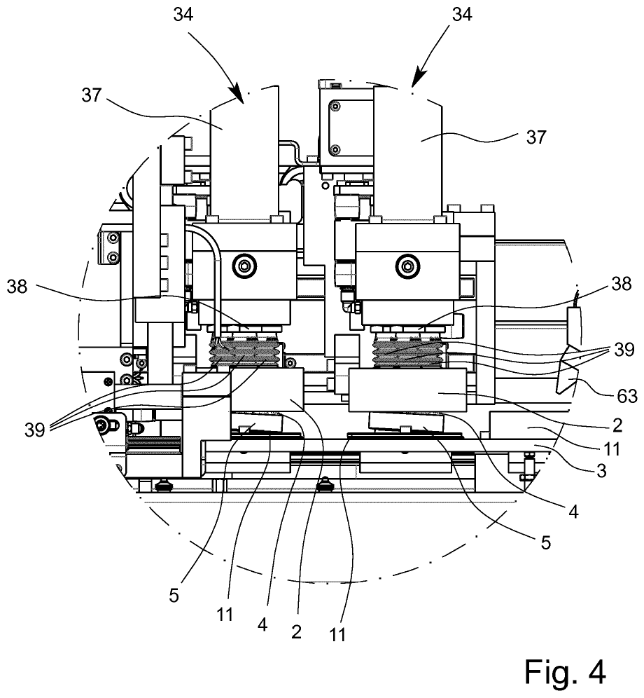

In a front view, FIG. 4 diagrammatically shows a cross-section of a blocking station 3 of the blocking apparatus 1) of FIG. 1 in a state in which two lenses 2 in the joining position of two block piece seats 11 are pressed by means of the transport apparatus 7 respectively into the block material 4 of a block piece 5 that is located in the respective block piece seat 11 and that is provided with block material 4. For better clarity, a respective border of the block piece seats 11, which are located in the joining position, is omitted here.

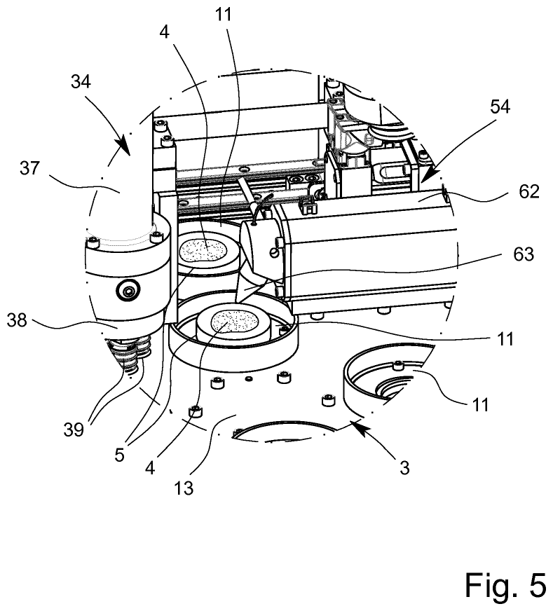

In a perspective view, FIG. 5 diagrammatically shows a cross-section of the blocking station 3 of the blocking apparatus 1 of FIG. 1 in a second state, in which two block pieces 5 that are provided with block material 4 are located in respectively one block piece seat 11 in the receiving position thereof.

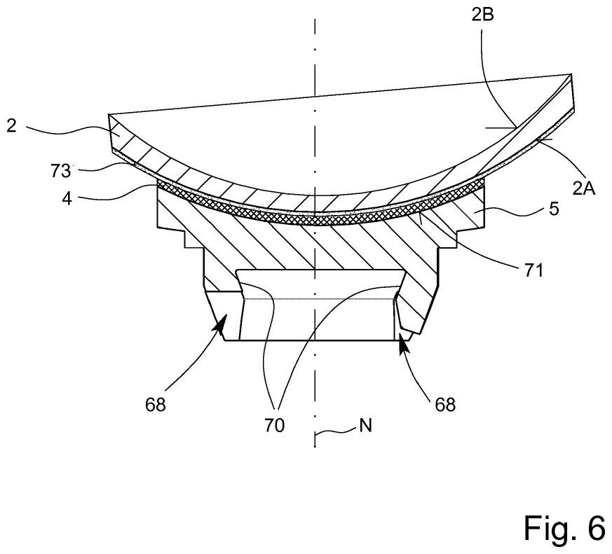

FIG. 6 diagrammatically shows a section through a block piece-lens pair 12.

In the embodiment that is depicted here and is preferred, each block piece seat 11 has a rotary protection for an anti-rotational seat of a block piece 5. The rotary protection can have, for example, a preferably rod-like support and at least one projection, which allow a receiving of the block piece 5 only in one rotational position around a C-axis by the block piece 5. To this end, the block piece 5 can be designed as shown in FIG. 6. There, on a lower side, the block piece 5 has two V-shaped recesses 68 and a rectangular notch 69. The recesses 68 allow the block piece 5 to be placed on the support of the block piece seat 11 in two rotational positions of the block piece 5 around the C-axis. The notch 69 of the block piece 5 and the correspondingly arranged projection of the block piece seat 11 limit the placing of the block piece 5 on the support of the block piece seat 11 to precisely one rotational position of the block piece 5.

In each block piece seat 11, elastic grapplers can be provided, which when a block piece 5 is placed in the block piece seat 11 grip behind an undercut 70 of the block piece 5. This increases the holding of the block piece 5 in the block piece seat 11. When a block piece-lens pair 12 is removed from the block piece seat 11 in the removal position, the grapplers are pressed away by pulling up the block piece-lens pair 12 by means of the recycling device 42.

The apparatus 1 can have means to detect by dynamic air speed indication in the joining position of the block piece seats 11 whether one block piece 5 is located respectively in the block piece seats 11. In particular, the apparatus 1 can be designed in such a way that it can be detected whether a block piece 5 that is located in the block piece seat 11 is arranged in a torque-proof manner and/or seals off the block piece seat 11 in an air-tight manner.

One or more block piece seat(s) can be designed in such a way that the major axis thereof is inclined with respect to the vertical and/or the turntable 13. In particular, each block piece seat 11 can have a support 74 for a block piece 5, wherein the normal at the midpoint of the support 74 is inclined with respect to the vertical. For example, the inclination of all block piece seats 11 can be constant and/or identical and/or approximately 1° to 4°.

A block piece 5 is preferably used for this apparatus 1, which block piece has a receiving surface 71 for a lens 2, wherein the normal N at the midpoint of the receiving surface 71 of the block piece 5 is inclined with respect to the vertical and the block piece 5 is inserted into a block piece seat 11 so that during joining with a lens 2, liquid block material 4 that is applied on the receiving surface 71 is distributed as uniformly as possible and/or over the entire surface between lens 2 and block piece 5 and/or does not flow from the receiving surface 71, in particular wherein the absolute value of the resulting inclination of the normal N at the midpoint of the receiving surface 71 of the block piece 5 is not more than 1° with respect to the vertical.

Thus, e.g., it can be provided to use block pieces 5 whose respective normals are inclined differently at the midpoint of the receiving surface 71, e.g., approximately 1° to 5°, and/or which have different radii. In this case, it is preferred when the inclination and/or rotational position of the block piece 5 is/are previously known and, optionally, the block piece 5 is provided to the blocking apparatus 1 that is oriented in the previously-known rotational position. Alternatively, the blocking apparatus 1 can be designed so that the block piece 5 can rotate by 180° around a C-axis, in order to calibrate the inclination of the block piece 5 to the inclination of the block piece seat 11. Again alternatively, the blocking apparatus 1 can be designed so that it detects a rotational position of the block piece 5 and can change accordingly, so that during blocking with a lens 2, liquid block material 3 that is applied to the receiving surface 71 is distributed as uniformly as possible and/or over the entire surface between the lens 2 and the block piece 5 and/or does not flow from the receiving surface 71, in particular so that the absolute value of the resulting inclination of the normal N at the midpoint of the receiving surface 71 of the block piece 5 with respect to the vertical of the blocking station 3 is not more than approximately 3°, in particular not more than approximately 1°.

In the embodiment that is depicted here and is preferred, the blocking apparatus 1 has precisely one centering device 14 for centering a lens 2 that is to be blocked and precisely one optical measuring station 15 for acquiring orientation and geometry information of a lens 2 that is to be blocked.

The centering device 14 has a support 16 and two slides 17 that can move in opposite directions in the X-direction, by means of which a lens 2 can be pushed into a centered position. Thus, lenses 2 of different sizes can be centered. The design of the centering device 14 is economical and rugged.

The optical measuring station 15 has a measuring surface 18 and a camera 19 that is arranged above the measuring surface 18 and an illuminating source that is arranged under the measuring surface 18 (not shown).

In the embodiment that is depicted here and is preferred, the transport apparatus 7 is designed for sequential transport of the lenses to the centering device 14 and to the measuring station 15. To this end, the transport apparatus 7 has the following devices:
a lens feeding device 20, by means of which the lenses 2 can be removed sequentially from a supply container 21, can be moved from the supply container 21 to the centering device 14, and can be placed in the centering device 14,
a pivoting device 22, by means of which the lenses 2 can be removed sequentially from the centering device 14 and can be moved from the centering device 14 to a transfer position, and can be pivoted namely by approximately 180°,
a first lens traversing device 23, by means of which the lenses 2 can be received sequentially from the transfer position, can be moved to the measuring station 15, can be placed on the measuring surface 18 of the measuring station 15, can be received by the measuring surface 18, can be moved to the aligning apparatus 6, in particular to its aligning devices 8, and can be placed in the aligning apparatus 6, in particular in its aligning devices 8, and
a second lens traversing device 24, by means of which the lenses 2 can be removed at least partially chronologically overlapping from the aligning apparatus 6, in particular from its aligning devices 8, can be moved from the aligning apparatus 6, in particular from its aligning devices 8, to one block piece 5 apiece that is located in the blocking station 3, in particular to two block piece seats 11 of the blocking station 3 into its joining position, and can be connected respectively with the one block piece 5 apiece that is provided with block material 4 to respectively one block piece-lens pair 12.

In the embodiment that is depicted here and is preferred, the lens feeding device 20 is moveable in the Y-direction along a linear axis Y₃. To this end, the lens feeding device 20 has a sled 26 that can move on a guide rail 25. In addition, the lens feeding device 20 can move in the Z-direction along a linear axis Z₃. To this end, the lens feeding device 20 has a pneumatic lifting cylinder 27. A suction device 28 for suctioning a lens 2 from the supply container 21 and placing a lens 2 on the support 16 of the centering device 14 is provided on the lifting cylinder 27.

In the embodiment that is depicted here and is preferred, the supply container 21 is a transport crate with two nests for one lens 2 apiece and two nests for one block piece 5 apiece.

The pivoting device 22 can rotate around a rotational axis A₄ by approximately 180°. The pivoting device 22 has a suction device 29, by means of which a lens 2 can be received by the support 16 of the centering device 14. By means of the pivoting device 22, the side position of a lens 2 can be exchanged. Thus, the suction device 29 can receive a lens 2 on its block side 2A that points upward in FIG. 2 and can rotate so that the processing side 2B of the lens 2 points upward.

The first lens traversing device 23 can move in the X-direction along a linear axis X₅ without position control. To this end, the first lens traversing device 23 has a sled 31 that can move on a guide rod 30. In addition, the first lens traversing device 23 can move in the Z-direction along a linear axis Z₅. To this end, the first lens traversing device 23 has a pneumatic lifting cylinder 32. A gripper 33 is provided on the lifting cylinder 32, by means of which gripper the first lens traversing device 23 can grip a lens 2 on its edge. By means of the gripper 33, the first lens traversing device 23 can grip a lens 2 by the suction device 29 of the pivoting device 22 in its transfer position. The gripped lens 2 can be moved by means of the first lens traversing device 23 to the measuring station 15 or to one of the aligning devices 8.

In FIG. 2, for purposes of clarity, parts of the first lens traversing device 23, in particular the sled 31, the lifting cylinder 32 and the gripper 33, are not shown.

The second lens traversing device 24 has two lens traversing modules 34. The two lens traversing modules 34 are not coupled with respect to movement; therefore, they can move independently of one another. Both lens traversing modules 34 can move in a position-controlled manner in the X-direction along a common linear axis X₆. To this end, the second lens traversing device 24 has a guide rod 35, and each lens traversing module 34 has a movable sled 36. Each lens traversing module 34 can move in a position-controlled manner in the Z-direction along a linear axis Z₆ₐ and/or Z_{6b}. To this end, each lens traversing module 34 has a pneumatic lifting cylinder 37. On each lifting cylinder 37, a retaining head 38 with three suction devices 39 for suctioning and removing a lens 2 from an assigned aligning device 8 are provided.

By means of the retaining heads 38, the lenses 2 can be held in their respectively defined rotational position, in which lenses 2 were first rotated by means of the aligning apparatus 6 relative to the respective retaining head 38. This also applies when joining the lenses 2 to the respective block piece 5. The forces that occur when pressing the lenses 2 into the block material 3 on the lens 2 do not change the defined rotational position of the respective lens 2. To this end, spacers that can clamp the respective lens 2 in a torque-proof manner are arranged in the suction devices 39 (not shown).

By means of the lens traversing module 34, two lenses 2 that are at least partially chronologically overlapping can be removed from the aligning devices 8, can be moved to one block piece 5 apiece, which is located in a block piece seat 11 of the blocking station 3 in the joining position, and can be pressed into the block material 4 of the block piece 5 that is provided with block material to generate two block piece-lens pairs 12. The lens traversing module 34 can in this case be moved in the Z-direction, so that between the respective lens 2 and the respective block piece 5, a gap remains, which gap is at least partially filled with the block material 4.

By means of the second lens traversing device 24, a relative movement can thus be implemented between a lens 2 that is held by the transport apparatus 7 and the aligning station 6.

The linear axis X₅ of the first lens traversing device 23 and the linear axis X₆ of the second lens traversing device 24 run in the Y-direction, offset parallel to one another. Thus, a lens 2 can be moved from the first lens traversing device 23, while one or two other lenses 2 can be moved from the second lens traversing device 24.

The measuring surface 17 of the measuring station 15, the two aligning devices 8 and the block piece seats 11 are arranged in their joining position so that the lenses 2 on the measuring surface 17, in the two aligning devices 8 and in the block piece seats 11 in their joining position can be reached both by the first lens traversing device 23 and by the second lens traversing device 24 (offset in the Y-direction). In particular, a straight line runs in the X-direction through the measuring surface 17, the two aligning devices 8, and the block piece seats 11 in their joining position.

In the embodiment that is depicted here and is preferred, the blocking apparatus 1 has a conveyor belt 66, by means of which multiple supply containers 21 can move at the same time. Each supply container 21 can receive two lenses 2 and two block pieces 5. The conveyor belt 66 can move here exclusively in a circumferential direction, so that the supply containers 21 can move exclusively in one direction, from left to right in FIGS. 1 and 2.

The supply containers 21 can be halted at multiple positions along the conveyor belt 66. To this end, multiple stoppers 40 are arranged along the conveyor belt 66. Thus, a first lens removal position is provided, in which the lens feeding device 20 [sic], a lens 2 can be removed from the corresponding supply container 21. At a second lens removal position, the lens feeding device 20 can remove another lens 2 from the corresponding supply container 21.

At a first block piece removal position, a block piece feeding device 41 can remove a block piece 5 from the corresponding supply container 21. At a second block piece removal position, the block piece feeding device 41 can remove another block piece 5 from the corresponding supply container 21.

At a return position, a recycling device 42 can place two block piece-lens pairs 12 in the corresponding supply container 21 at the same time, from which container the lenses 2 and the block pieces 5 of the two block piece-lens pairs 12 were removed.

By means of the block piece feeding device 41, a block piece 5 can be removed from a supply container 21 in the block piece removal position and can be placed in a block piece seat 11 in the receiving position. The block piece feeding device 41 can move in the X-direction along a linear axis X₇. To this end, the block piece feeding device 41 has a sled 44 that can move on a guide rod 43. In addition, the block piece feeding device 41 can move in the Y-direction along a linear axis Y₇ₐ and a linear axis Y_{7b}. To this end, the block piece feeding device 41 has a second sled 45, which can move in the Y-direction, and a belt 46, which can move on the second sled 45 in the Y-direction. Moreover, the block piece feeding device 41 can move in the Z-direction along a linear axis Z₇. To this end, the block piece feeding device 41 has a pneumatic lifting cylinder 47. A suction device 48 is provided at the lifting cylinder 47.

By means of the recycling device 42, two block piece-lens pairs 12 can be removed from two block piece seats 11 in their removal position at the same time and transported to a supply container 21 on the conveyor belt 66 and placed in the supply container 21. The recycling device 42 has two retaining heads 49, which are coupled with respect to movement. The recycling device 42 can move in the Y-direction along a linear axis Y₈. To this end, the recycling device 42 has a sled 51 that can move on a guide rail 50. In addition, the recycling device 42 can move in the Z-direction along a linear axis Z₈. To this end, the recycling device 42 has a pneumatic lifting cylinder 52. A suction device 53 on a gimbal is provided on each retaining head 49. Each retaining head 49 can rotate around a rotational axis C₈, in particular by approximately 90°. As a result, a block piece-lens pair 12 can be rotated so that it can be placed in the supply container 21 at the point where the lens 2 of the block piece-lens pair 12 was first located.

In the embodiment that is depicted here and is preferred, the blocking apparatus 1 has a block material feeding device 54. By means of the block material feeding device 54, block material 4 can be applied sequentially to two block pieces 5, which are located in each case in a block piece seat 11 in their receiving position. The block material feeding device 54 is designed for automated loading of a thermoplastic block material 4 in the solid aggregate state, specifically in rod form.

To this end, the block material feeding device 54 has a loading device 55 with trays 56 that are arranged like steps, a lifting apparatus 57 that is arranged between the trays 56 and is step-like, with multiple steps 58, a loading surface 59 and a feeding surface 60. Block material cylinders 4 can be placed on the chamfered loading surface 59. Following the inclined surface of the loading surface 59, the block material cylinders 4 roll under a first step 58 of the lifting apparatus 57. The lifting apparatus 57 can move in the Z-direction. By moving the lifting apparatus 57 upward, multiple block material cylinders 4 are pressed upward into one of the trays 56. After moving the lifting apparatus 57 downward into the starting position, the block material cylinders 4 that are pressed upward roll under a second step 58 of the lifting apparatus 57. This second step 58 has a smaller depth than the first step 58. By moving the lifting apparatus 57 upward, multiple block material cylinders 4, although fewer than before, are pressed upward into another tray 56. After moving the lifting apparatus 57 downward into the starting position, the block material cylinders 4 that are pressed upward roll under a third step 58 of the lifting apparatus 57. This third step 58 has a smaller depth than the second step 58, so that only one block material cylinder 4 from the third step can be pressed upward. By moving the lifting apparatus 57 upward, a block material cylinder 4 is pressed upward to the chamfered feeding surface 60. Following the inclined surface of the feeding surface 60, the block material cylinder 4 that is pressed upward rolls into a seat 72 of the block material feeding device 54.

The block material cylinder 4 in the seat 72 can be pushed by means of a slide 61 of the block material feeding device 54 in sections into a combustion chamber 62 of the block material feeding device 54. In the combustion chamber 62, the block material cylinder 4 can be heated in certain areas, in particular a front area of the block material cylinder 4, specifically to at least its melting point.

The molten block material 4 can be dispensed in metered form by means of a nozzle 63 from the block material feeding device 54. To this end, the block material 4 can be inserted further into the combustion chamber 62 by means of the slide 61, so that molten block material 4 can be dispensed from the nozzle 63.

The molten block material 4 in the combustion chamber 62 can be cooled in certain areas by means of a cooling device.

The block material feeding device 54 can move in the Y-direction along a linear axis Y₉. The nozzle 63 of the block material feeding device 54 is arranged above the block piece seats 11 in their receiving position.

In the embodiment that is depicted here and is preferred, the blocking apparatus has two measuring key buttons 64. A measuring probe 64 is arranged beside the turntable 13 of the blocking station 3, and the other measuring probe 64 is arranged below the turntable 3. The measuring probes 64 can be moved in the Z-direction. For the other measuring key buttons 63, the turntable 13 has a corresponding notch 65 between two block piece seats 11 of a block piece seat pair.

By means of the measuring probes 64, it can be determined whether the corresponding retaining head of a lens traversing module 34 holds a lens 2 or not. If the retaining head 38 holds a lens 2, a central area of the lens 2 that is held can be measured, the radius of the held lens 2 and/or the distance from the respective measuring key button 64 to a point on the lens 2 can be determined. These measurements can be taken into consideration when pressing the lens 2 into the block material 4 of a block piece 5.

According to the embodiment that is depicted and is preferred, the blocking apparatus 1 makes possible a throughput of approximately 100 to approximately 180 blocked lenses per hour.

Below, a preferred embodiment of the method according to the invention for blocking of lenses, in particular eyeglass lenses, is explained.

First, a supply container 21 is moved by means of the conveyor belt 66 to the first lens removal position. The lens feeding device 20 removes a lens 2 from the supply container 21. In this case, the suction device 28 suctions the lens feeding device 20 on the block side 2A of the lens 2.

By moving the lens feeding device 20 in the Z- and Y-directions, the lens 2 is placed on the support 16 of the centering device 14. Lying there, the lens 2 is centered by moving the slide 17 of the centering device 14.

After the centering, the pivoting device 22 is pivoted from its transfer position to the centering device 14. The suction device 29 of the pivoting device 22 suctions the lens 2 on its block side 2A and removes it from the centering device 14 by the pivoting device 22 being pivoted into its transfer position. The processing side 2B now shows the lens 2 upward.

In the meantime, the lens feeding device 20 removes another lens 2 from the same supply container 21. To this end, the supply container 21 has first been moved by means of the conveyor belt 66 into its second lens removal position.

The gripper 33 of the first lens traversing device 23 is moved to a position above the suction device 29 of the pivoting device 22 by traversing in the X- and Z-directions. There, the lens 2 is gripped by the gripper 33 and removed from the pivoting device 22.

By moving the first lens traversing device 23 in the X- and Z-directions, the lens 2 is placed on the measuring surface 18 of the measuring station 15. After acquiring orientation and geometry information of the lens 2, this lens 2 is removed from the measuring station 15 by moving the first lens traversing device 23 in the X- and Z-directions and is placed in one of the aligning devices 8.

It is also possible to place the lens 2 directly into one of the aligning devices 8 by moving the first lens traversing device 23 in the X- and Z-directions by the pivoting device 22, e.g., when orientation and geometry information of the lens 2 is not needed.

Meanwhile, the additional lens 2 was moved to the centering device 14, centered there, and pivoted by the pivoting device 22 into the transfer position. The gripper 33 of the first lens traversing device 23 is moved again to a position above the suction device 29 of the pivoting device 22 by traversing in the X- and Z-directions. There, the additional lens 2 is gripped by the gripper 33, and removed from the pivoting device 22.

The additional lens 2 can run to the measuring station 15 or be placed directly in the other aligning device 8. A lens 2 is now located in each aligning device 8.

The lenses 2 are oriented at least partially chronologically overlapping by means of the two aligning devices 8, i.e., rotated in a position-controlled manner in respectively one defined rotational position.

After the first lens traversing device 23 was moved away from the aligning devices 8 (for example, for removing another lens 2 from the pivoting device 22), the suction devices 39 of the one lens traversing module 34 of the second lens traversing device 24 are positioned by moving in the X- and Z-directions to a position above the one lens 2 in the one aligning device 8. At least partially chronologically overlapping, the suctioning devices 39 of the other lens traversing module 34 of the second lens traversing device 24 are positioned by moving in the X- and Z-directions to a position above the other lens 2 in the other aligning device 8.

At least partially chronologically overlapping, each lens traversing module 34 removes a lens from the respective aligning device 8 and moves the respective lens 2 into a position above the respective measuring probe 64. The measuring key buttons 64 are moved in the Z-direction upward on the block side 2A of the respective lens 2. The measuring probes 64 detect the lowest points of the respective lens 2. The measuring probes 64 are then moved downward in the Z-direction. The measuring probes 64 can also be omitted.

In any case, each lens traversing module 34 runs the respective lens 2 to a position above a respective block piece seat 11 of a block piece seat pair at their joining position. One block piece 5 apiece is located in both block piece seats 11. Block material 4 is first applied by means of the block material feeding device 54 to the block pieces 5. The block pieces 5 were first placed by means of the block piece feeding device 41 into the block piece seats 11 in their receiving position. To this end, the supply container 21 was moved by means of the conveyor belt 66 to the first block piece removal position, at which the block piece feeding device 41 has removed a first block piece 5 from the supply container 21. The block piece 5 was placed by the block piece feeding device 41 into one of the block seats 11 in its receiving position. In the meantime, the supply container 21 was moved by means of the conveyor belt 66 to the second block piece removal position, at which the block piece feeding device 41 has removed a second block piece from the supply container. The second block piece 5 was placed by the block piece feeding device 41 in the other block seat 11 in its receiving position. After the application of the block material 4, the turntable 13 of the block station 3 was rotated by 90°, so that the block piece seats 11 with the block pieces 5 that are provided with block material 4 are located in the joining position.

In the joining position of the block piece seats, both lenses 2 are pressed by means of the lens traversing module 34 at least essentially at the same time into the block material 4 of the respective block piece 5. In this way, two block piece-lens pairs 12 are generated. The lenses 2 are held to the respective block piece 5 at a predefined distance, specifically for a minimum time. In this minimum time, the block material 4 is to harden so that a minimum strength of the block material 4 and thus a minimum hold between lens 2 and block piece 5 is achieved. The minimum hold is characterized in that the suction devices 39 of the respective retaining head 38 can be released from the resulting block piece-lens pair 12 without the block piece 5 and the lens 2 being separated from one another. The minimum time is typically between approximately 15 s and approximately 45 s.

After the minimum time elapses, the turntable 13 of the blocking station 3 is rotated another 90° so that the block piece seats 11 with the two generated block piece-lens pairs 12 are located in the rest position. There, the block material 4 further hardens during a waiting period. The waiting period is typically approximately between 30 s to 60 s.

After the waiting period elapses, the turntable 13 of the blocking station 3 is rotated another 90°, so that the block piece seats 11 with the two previously-considered block piece-lens pairs 12 are located in the removal position. Here, the two block piece-lens pairs 12 are removed at least essentially simultaneously by means of the recycling device 42 from the respective block piece seat 11, rotated around the rotational axis C₈ by 90° by means of the respective retaining head 49 of the recycling device 42, with respect to the supply container 21, from which the two lenses 2 and the two block pieces 5 of the two block piece-lens pairs 12 were removed, transported, and placed in this supply container 21. This is carried out in particular after two other block pieces were placed in two other block piece seats 11 in their receiving position, and block material 4 was applied on these two other block pieces 5.

After the two block piece-lens pairs 12 are removed, the turntable 13 of the blocking station 3 is rotated another 90°, so that the now empty block piece seats 11 are again located in the receiving position.

In the method according to the invention, the sequence of events of the individual method steps is to be calibrated. In particular, the sequence of events is to be calibrated so that the lenses 2 are moved at the correct time into the correct position, in particular in such a way that the first lens traversing device 23 and the second lens traversing device 24 do not collide with one another.

In addition, it should be ensured that the application of the block material 4 to the block piece 5 is carried out at the proper time before the turntable 13 of the blocking station 3 rotates. The application should also not be done too early, however, since ultimately, the molten block material 4 on the block pieces 5 is not to cool too long before the joining is done, since otherwise there is the danger of an unstable connection between the block piece 5 and the lens 2. Preferably, the sequence of events is clocked so that the temperature of the block material 3, which is applied to a block piece 5, which is located in a block piece seat 11 in the joining position, lies in a range of approximately 50° C. to approximately 70° C. just before joining takes place. This makes possible a high adhesive power (and thus a stable connection) between the lens 2 and the block material 3.

The hardening of the block material 4 can be controlled by means of a thermal imaging camera. It is also possible to heat the block piece 5 before the joining, preferably before the application of the block material 4, in order to slow down the hardening of the block material 4.

Moreover, the sequence of events is to be calibrated so that the block piece feeding device 41, the recycling device 42, and the block material feeding device 54 do not collide with one another.

In the previously-explained preferred embodiment of the method according to the invention, information with respect to the defined rotational position of the lenses 2 is transmitted in electronic form to a processing apparatus. The transmission is done in a wired manner by means of a communication device of the blocking apparatus 1.

What is claimed is:

1-46. (canceled)

47. Method for blocking of lenses comprising:
rotating at least two lenses by means of an aligning apparatus at least partially chronologically overlapping in a position-controlled manner in a respectively defined rotational position,
moving the lenses by means of a transport apparatus at least partially chronologically overlapping on a respective block piece that is located in a blocking station and holding the lenses in the respectively defined rotational position, and
detachably connecting the lenses in the blocking station directly with the respective block piece by means of the transport apparatus to form a block piece-lens pair, using a block material and in an at least partially chronologically overlapping manner.

48. Method according to claim 47, wherein
at least two block pieces are arranged in the blocking station,
in each case, block material is applied to the two block pieces that are located in the blocking station, and
the two block pieces that are provided with block material are moved by means of the blocking station relative to the transport apparatus into a joining position in which the lenses are connected with the respective block piece in a detachable manner at least partially chronologically overlapping to form the block piece-lens pair.

49. Method according to claim 48, wherein for detachably connecting of the lenses with the block pieces, the lenses are at least partially chronologically overlappingly pressed in the block material on the respective block piece by means of the transport apparatus.

50. Method according to claim 48, wherein in a joining position, the lenses are held at a predefined distance from the respective block piece for a minimum time, during which the block material hardens in such a way that a minimum strength of the block material, and thus a minimum hold between the respective lens and the respective block piece, is achieved.

51. Method according to claim 48, wherein the two block piece-lens pairs are moved by means of the blocking station relative to the transport apparatus into a rest position, in which the block material partially hardens.

52. Method according to claim 47. wherein the two block piece-lens pairs are moved by means of the blocking station relative to the transport apparatus into a removal position. in which the two block piece-lens pairs are removed from the blocking station.

53. Method according to claim 47, wherein, during the detachable connecting of the lenses with the block pieces to form the block piece-lens pair, the block material of two already-generated block piece-lens pairs partially hardens in the rest position, two additional block piece-lens pairs are removed in the removal position, and two other block pieces are arranged in the blocking station.

54. Method according to claim 47, wherein the blocking station is rotated around a rotational axis.

55. Method according to claim 47, wherein at least one additional block piece is arranged in the blocking station at least partially chronologically overlapping with the detachably connecting of the two block piece-lens pairs.

56. Method according to claim 55, wherein block material is applied to this additional block piece that is located in the blocking station.

57. Method according to claim 47, wherein at least partially chronologically overlapping with the detachably connecting of two block piece-lens pairs. at least one block piece-lens pair pauses in the rest position for partial hardening of the block material.

58. Method according to claim 47, wherein at least partially chronologically overlapping with the detachably connecting of two block piece-lens pairs, at least one additional block piece-lens pair is removed from the blocking station.

59. Apparatus for blocking of lenses, comprising:
a blocking station for at least partially chronologically overlappingly connecting at least each of two lenses directly to a respective block piece that is provided with a block material,
an aligning apparatus for at least partially chronologically overlappingly position-controlled rotating of the lenses around three rotational axes in a defined rotational position. and
a transport apparatus for at least partially chronologically overlappingly transporting the lenses to a respective block piece that is located in the blocking station and for holding the lenses in the respectively defined rotational position.

60. Apparatus according to claim 59, wherein the aligning apparatus is additionally adapted to at least partially chronologically overlappingly provide position-controlled moving of the lenses along a linear axis.

61. Apparatus according to claim 59, wherein the aligning apparatus has two aligning devices, each of which is adapted to provide position-controlled rotation of the lenses around three rotational axes in the respectively defined rotational position.

62. Apparatus according to claim 61, wherein the two aligning devices are also adapted for position-controlled moving of the lenses along a linear axis.

63. Apparatus according to claim 59, wherein the blocking station has at least two block piece seats, each one being for a respective block piece, and in a joining position of the block piece seats, the lenses are connectable in a detachable manner with a respective one of the block pieces that is located in the respective block piece seat and is provided with block material to form a respective block piece-lens pair.

64. Apparatus according to claim 63, wherein, in the joining position of the block piece seats, the lenses can be pressed by means of the transport apparatus into the block material of the respective block piece that is located in the respective block piece seat and that is provided with block material.

65. Apparatus according to claim 63, wherein the blocking station is movable with the block piece seats thereon relative to the transport apparatus.

66. Apparatus according to claim 63, wherein the block piece seats are coupled to move in unison.

67. Apparatus according to claim 63, wherein the block piece seats are movable into a receiving position, in which each block piece is arrangeable in a respective block piece seat, and block material is deliverable onto the block pieces that are located in the block piece seats.

68. Apparatus according to claim 63, wherein the block piece seats are movable into the joining position.

69. Apparatus according to claim 63, wherein the block piece seats are movable into a rest position for partial hardening of the block material of the block piece-lens pairs.

70. Apparatus according to claim 63, wherein the block piece seats are movable into a removal position in which the block piece-lens pairs can be removed from the block piece seats.

71. Apparatus according to claim 67, wherein the blocking station has four pairs of block piece seats with two block piece seats apiece, the block piece seats being arranged in the blocking station so that a first block piece seat pair is movable into the receiving position, while a second block piece seat pair is movable into the joining position, and a third block piece seat pair is movable into the rest position, and a fourth block piece seat pair is movable into the removal position.

72. Apparatus according to claim 59, wherein the transport apparatus is adapted for removing lenses from the aligning apparatus, wherein the transport apparatus has at least two retaining heads for holding the lenses in the respectively defined rotational position and by means of the aligning apparatus, the lenses are rotatable relative to the respective retaining head in the respectively defined rotational position.

73. Apparatus according to claim 59, wherein the transport apparatus has two linear axes that run parallel to one another.

74. Apparatus according to claim 73, wherein one of the two linear axes is position-controlled.

75. Apparatus according to claim 73, wherein the lenses are moveable along said one of the two linear axes to the aligning apparatus and along the other linear axis to a block piece that is located in the blocking station.

76. Apparatus according to claim 73, wherein the transport apparatus has a first lens traversing device, wherein by means of the first lens traversing device, the lenses are movable to and positionable in the aligning apparatus.

77. Apparatus according to claim 73, wherein the transport apparatus has a second lens traversing device, wherein by means of the second lens traversing device, the lenses are removable from the aligning apparatus, are movable to a respective block piece that is located in the blocking station, and are connectable with the respective block piece provided with block material.

78. Apparatus according to claim 59, wherein the apparatus has a centering device for centering a lens that is to be blocked and a measuring station for acquiring orientation and geometry information of a lens that is to be blocked, and wherein the transport apparatus is adapted to transport the lenses to the centering device and to the measuring station.

79. Apparatus according to claim 78, wherein the transport apparatus has a lens feeding device, by means of which the lenses are removable from a supply container, are movable to the centering device, and are positionable in the centering device.

80. Apparatus according to claim 78, wherein the transport apparatus has a pivoting device by means of which the lenses are removable from the centering device and are movable from the centering device to a transfer position.

81. Apparatus according to claim 78, wherein the transport apparatus has a first lens traversing device, by means of which the lenses are receivable from the transfer position, are movable to the measuring station, are positionable in the measuring station, are removable from the measuring station, are movable to the aligning apparatus, and are positionable in the aligning apparatus.

82. Apparatus according to claim 81, wherein the transport apparatus has a second lens traversing device, by means of which the lenses are removable from the aligning apparatus, are movable from the aligning apparatus to a respective block piece that is located in the blocking station, and are connectable with the respective block piece provided with block material.

83. Apparatus according to claim 59, wherein the apparatus has a conveyor belt by means of which a supply container for lenses and block pieces is moveable exclusively in one direction.

84. Apparatus for blocking lenses, comprising at least one block piece seat for a block piece, wherein a major axis of the block piece seat is inclined with respect to vertical.

85. Block material feeding device for an apparatus for blocking of lenses, comprising:
means for automated loading of a thermoplastic block material in the solid aggregate state,
means for heating certain areas of the thermoplastic block material, and
means for metered dispensing of the molten block material.

86. Block material feeding device according to claim 85, further comprising means for cooling the block material located in the block material feeding device.

87. Method for blocking and processing an eyeglass lens, comprising:
blocking the lens in a blocking apparatus on a block piece that is provided with block material in a defined rotational position relative to the block piece,
transmitting in electronic form at least one piece of information about to the defined rotational position of the lens to a processing apparatus, and
processing the blocked lens by the processing apparatus while taking into consideration the transmitted information about the defined rotational position of the lens.

88. Method according to claim 87, further comprising rotating the lens in the blocking apparatus around three rotational axes in a position-controlled manner in the defined rotational position relative to the block piece.

89. Method according to claim 87, wherein the processing of the blocked lens by the processing apparatus is started at a position that depends on the transmitted information about the defined rotational position of the lens.

90. Method for blocking an eyeglass lens on a block piece having a prismatically tilted receiving surface for the lens using a block material, comprising the steps of:
during blocking, holding the block piece in an inclined block piece seat in such a way that the prismatically tilted receiving surface is oriented at least essentially horizontally.

91. Method for blocking a prismatic eyeglass lens on a block piece by means of a block material, comprising:
providing an inclined block piece seat by providing the block piece with a prismatically tilted receiving surface for the lens, and,
providing the receiving surface with a prismatic tilting that is less than a desired prism of the lens, and
taking into consideration the difference between the prismatic tilting of the receiving surface and the desired prism of the lens during processing of the blocked lens, so that the desired prism of the lens is generated.

92. Method according to claim 90, wherein at least one of a major axis of the block piece seat or a normal at the midpoint of a receiving surface of the block piece is inclined by 1° to 5° with respect to vertical.
